(19) United States
(12) Patent Application Publication
(10) Pub. No.: US 2022/0057779 A1
(43) Pub. Date: Feb. 24, 2022

(54) METHOD AND DEVICE FOR INTELLIGENTLY CONTROLLING CONTINUOUS PROCESSING OF FLEXIBLE MATERIAL

(71) Applicant: GUANGDONG UNIVERSITY OF TECHNOLOGY, GUANGZHOU (CN)

(72) Inventor: Yaohua DENG, GUANGZHOU (CN)

(73) Assignee: GUANGDONG UNIVERSITY OF TECHNOLOGY

(21) Appl. No.: 17/037,661

(22) Filed: Sep. 29, 2020

(30) Foreign Application Priority Data
Aug. 20, 2020 (CN) 202010843403.8

(51) Int. Cl. G05B 19/4155; G06T 7/00

(52) U.S. Cl. CPC G05B 19/4155; G05B 2219/40052; G06T 2207/30124; G06T 7/0004

(57) ABSTRACT

Disclosed is a method and device for controlling continuous processing of a flexible material, which includes generating an outer profile diagram and a defect profile diagram from an image of a collected flexible material; converting and merging the outer profile diagram and the defect profile diagram to generate a vector data format file of profile information; typesetting according to an outer profile and a defect profile of the vector data format file of profile information, so as to generate a graphic format file of a profile to be processed; converting the graphic format file of the profile to be processed into a graphic language format file of the profile to be processed; performing trajectory optimization to generate an industrial-standard HPGL instruction; compiling the industrial-standard HPGL instruction to generate a control signal; and transmitting the control signal to a motion execution system, and performing cutting by the motion execution system.

### CROSS-REFERENCE TO RELATED APPLICATIONS

This application claims priority to Chinese Patent Application No. 202010843403.8 with a filing date of Aug. 20, 2020. The content of the aforementioned applications, including any intervening amendments thereto, are incorporated herein by reference.

### TECHNICAL FIELD

The present application relates to the technical field of intelligent numerical control, and in particular to a method and device for intelligently controlling continuous processing of a flexible material.

### BACKGROUND OF THE PRESENT INVENTION

A flexible material refers to a material that has certain softness and flexibility and is deformable without losing performance, which generally includes a clothing fabric, leather, a plastic film, etc. The flexible material is widely used in automobile, medical, aerospace, clothing, packaging and the like industries, and is an indispensable part of daily life. The cutting process of a flexible material includes three parts: scanning and identifying, sheet-stock typesetting and sheet-stock cutting, wherein scanning detection is to collect an outer profile and a defect profile of the flexible material to be processed. In the actual processing process, the flexible material, such as leather, has different outline dimensions and specifications, and there are more than a dozen large and small procedures in the process of making leather from genuine leather, which inevitably leaves various defects on the surface of the leather material. Therefore, it is necessary to extract the outer profile and defect profile of the leather to prepare for the subsequent sheet-stock typesetting. The sheet-stock typesetting is to scientifically and reasonably arrange the cutted pieces according to the outer profile and the defect profile of the sheet stock, in order to maximize the use of the material. Therefore, using scientific typesetting to improve the utilization rate of the flexible material is also one of the important means and ways to improve the economic benefits of production enterprises. The cutting process of the flexible material is to cut the typeset cutted pieces from the sheet stock by a digital controlled cutter according to a planned path.

At present, the devices for scanning and identifying, sheet-stock typesetting and cutting processes during the processing of the flexible material are all single set of devices produced by their respective manufacturers. In the process of processing the flexible material, the poor file compatibility among devices of various manufacturers and the discontinuous production process lead to reduction in the efficiency and precision of production of the flexible material.

### SUMMARY OF PRESENT INVENTION

The present application provides a method and device for intelligently controlling continuous processing of a flexible material, so as to solve the technical problem existed in the prior art that in the process of processing the flexible material, the poor file compatibility among devices of various manufacturers and the discontinuous production process lead to reduction in the efficiency and precision of production of the flexible material.

In view of this, a first aspect of the present application provides a method for intelligently controlling continuous processing of a flexible material, wherein the method for controlling the processing includes the following steps:

S1. collecting a flexible material placed on a conveying platform by a collecting device, so as to acquire an image of the flexible material;

S2. generating an outer profile diagram and a defect profile diagram according to the image of the flexible material;

S3. respectively converting and merging the outer profile diagram and the defect profile diagram, so as to generate a vector data format file of profile information;

S4. typesetting the vector data format file of profile information, so as to generate a graphic format file of a profile to be processed;

S5. converting the graphic format file of the profile to be processed, so as to generate a graphic language format file of the profile to be processed;

S6. performing trajectory optimization on the graphic language format file of the profile to be processed according to the profile to be processed, so as to generate an industrial-standard HPGL instruction for trajectory optimization;

S7. compiling the industrial-standard HPGL instruction for trajectory optimization, so as to generate a control signal; and

S8. transmitting the control signal to a motion execution system, and performing cutting by the motion execution system according to the control signal.

Preferably, the typesetting process specifically includes:

comprehensively considering multi-dimensional information such as an outer profile, an defective profile, cutted pieces, etc., so as to perform automatic typesetting of the outer profile with avoidance from the defective profile.

Preferably, the S2 specifically includes:

identifying and extracting an outer profile and a defect profile from the image of the flexible material according to a convolution network deep learning algorithm, so as to acquire the outer profile diagram and the defect profile diagram.

Preferably, the collecting process in the S1 specifically includes:

collecting the flexible material by a linear array scanning camera with a preset scanning range and a preset resolution.

Preferably, the preset scanning range is 2 m×2 m, and the preset resolution is 0.06 mm/pixel.

Preferably, the format of the image of the flexible material includes a JPG format, a PNG format, a GIF format, a BMP format, a TIF format and a PSD format;

the vector data format of the vector data format file of profile information includes a DXF format, a DWG format, a DWT format and a DWS format;

the graphic format of the graphic format file of the profile to be processed includes a CGM format and a CNS format;

the graphic language format in the graphic language format file of the profile to be processed includes an HPGL format, a PLT format and an HPG format.

The embodiments of the present invention also provides a device for intelligently controlling continuous processing of a flexible material, wherein the device for controlling the processing includes an image acquisition module, an outer profile extraction module, a defect profile extraction module, a profile file conversion module, a sheet-stock typesetting system module, a format conversion module, a trajectory optimization system module, an HPGL instruction generation module, a multi-core control module, and a motion execution system;

the image acquisition module is used for acquiring an image of a flexible material placed on a conveying platform, and conveying the acquired image of the flexible material to the outer profile extraction module and the defect profile extraction module;

the outer profile extraction module is used for extracting an outer profile of the received image of the flexible material, and sending the extracted outer profile to the profile file conversion module;

the defect profile extraction module is used for extracting a defect profile of the received image of the flexible material, and sending the extracted defect profile to the profile file conversion module;

the profile file conversion module is used for merging the received outer profile and defect profile to generate a vector data format file of profile information, and sending the vector data format file of profile information to the sheet-stock typesetting system module;

the sheet-stock typesetting system module is used for comprehensively considering multi-dimensional information such as an outer profile, an defective profile, cuffed pieces, etc., so as to perform automatic typesetting of the outer profile within the vector data format file of profile information with avoidance from the defective profile, so as to generate a graphic format file of a profile to be processed, and sending the graphic format file of the profile to be processed to the format conversion module;

the format conversion module is used for converting the received graphic format file of the profile to be processed, so as to generate a graphic language format file of the profile to be processed, and sending the graphic language format file of the profile to be processed to the trajectory optimization system module;

the trajectory optimization system module is used for performing trajectory optimization on the received graphic language format file of the profile to be processed according to the profile to be processed, so as to generate processing trajectory information, and sending the processing trajectory information to the HPGL instruction generation module;

the HPGL instruction generation module is used for generating an industrial-standard HPGL instruction from the received processing optimization trajectory information, and sending the industrial-standard HPGL instruction to the multi-core control module;

the multi-core control module is used for compiling the industrial-standard HPGL instruction, so as to generate a control signal, and sending the control signal to the motion execution system;

the motion execution system is used for receiving the control signal and cutting the flexible material according to the control signal.

Preferably, the device for controlling the processing also includes a sheet-stock typesetting display module;

the sheet-stock typesetting display module is used for acquiring and displaying the typesetting information in the sheet-stock typesetting system module.

Preferably, the multi-core control module is used for driving control of the motion execution system, receiving the HPGL instruction, and driving the motion execution system to execute actions according to the industrial-standard HPGL instruction.

Preferably, the motion execution system includes a material conveying platform for conveying the flexible material, an X-axis moving beam, a Y-axis moving pedestal and a cutting machine head, wherein the X-axis moving beam is mounted on the material conveying platform, the Y-axis moving pedestal is movably mounted on the X-axis moving beam, and the cutting machine head is mounted on the Y-axis moving pedestal while being capable of moving up and down.

It can be seen from the above technical solution that the embodiments of the present application has the following advantages.

The present application provides a method and device for intelligently controlling continuous processing of a flexible material, which includes generating an outer profile diagram and a defect profile diagram from an image of a collected flexible material; converting and merging the outer profile diagram and the defect profile diagram, so as to generate a vector data format file of profile information; typesetting according to an outer profile and a defect profile of the vector data format file of profile information, so as to generate a graphic format file of a profile to be processed; converting the graphic format file of the profile to be processed into a graphic language format file of the profile to be processed; performing trajectory optimization to generate an industrial-standard HPGL instruction; compiling the industrial-standard HPGL instruction to generate a control signal; and transmitting the control signal to a motion execution system, and performing cutting by the motion execution system. The present invention solves the technical problem existed in the prior art that in the process of processing the flexible material, the discontinuous process leads to reduction in the efficiency and precision of production of the flexible material.

### DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic flow chart of a method for intelligently controlling continuous processing of a flexible material, as provided by an embodiment of the present application;

FIG. 2 is a schematic structural diagram of a device for intelligently controlling continuous processing of a flexible material, as provided by an embodiment of the present application; and

FIG. 3 is another schematic structural diagram of a device for intelligently controlling continuous processing of a flexible material, as provided by an embodiment of the present application.

### DETAILED DESCRIPTION OF PREFERRED EMBODIMENTS

In order to make those of skills in the art understand the present application better, the following clearly and completely describes the technical solutions in the embodiments of the present application with reference to the accompanying drawings in the embodiments of the present application. Apparently, the described embodiments are merely a part rather than all of the embodiments of the present application. Based on the embodiments in the present application, all other embodiments obtained by those of ordinary skills in the art without creative labor are within the claimed scope of the present application.

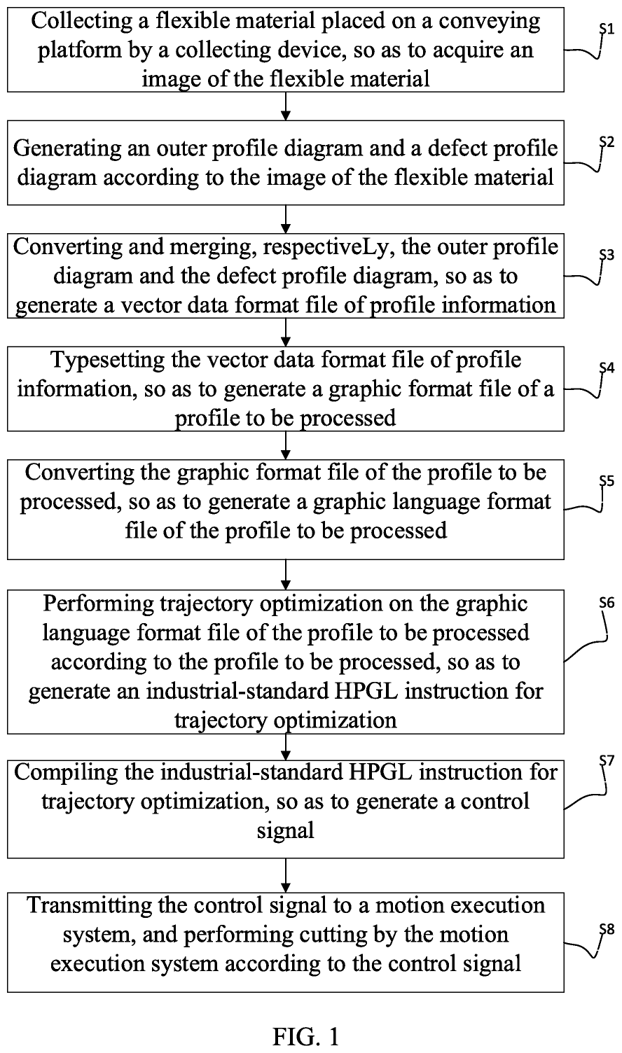

For convenience of understanding, referring to FIG. 1, Example 1 of a method for intelligently controlling continuous processing of a flexible material as provided by the present application includes the following steps.

S1. a flexible material placed on a conveying platform is collected by a collecting device, so as to acquire an image of the flexible material.

The collecting process in the S1 specifically includes:

collecting the flexible material by a linear array scanning camera with a preset scanning range and a preset resolution.

The preset scanning range is 2 m×2 m, and the preset resolution is 0.06 mm/pixel.

The flexible material is placed on the conveying platform, and moves slowly through the linear array scanning camera at an uniform speed. The linear array scanning camera conducts scanning and collecting on the flexible material to obtain the image information of the flexible material, wherein the format of the image of the flexible material is a JPG format, a PNG format, a GIF format, a BMP format, a TIF format and a PSD format.

S2. an outer profile diagram and a defect profile diagram is generated according to the image of the flexible material.

The S2 specifically includes:

identifying and extracting information of an outer profile and a defect profile from the image of the flexible material according to a convolution network deep learning algorithm, so as to acquire the outer profile diagram and the defect profile diagram. Through the convolution network deep learning algorithm, all the outer profile features and defect profile features can be used to the maximum extent, thereby improving the accuracy of identification and extraction.

S3. the outer profile diagram and the defect profile diagram are respectively converted and merged, so as to generate a vector data format file of profile information.

The outer profile diagram is converted into the vector data format file of outer profile information. The defect profile diagram is converted into the vector data format file of defect profile information. The vector data format file of outer profile information and the vector data format file of defect profile information are merged into the vector data format file of profile information.

The vector data format of the vector data format file of profile information includes a DXF format, a DWG format, a DWT format and a DWS format.

S4. the vector data format file of profile information is typeset, so as to generate a graphic format file of a profile to be processed.

Multi-dimensional information such as an outer profile, an defective profile, cuffed pieces, etc., are comprehensively considered, so as to perform automatic typesetting of the outer profile with avoidance from the defective profile. After typesetting, the graphic format file of the profile to be processed is generated, such that the purpose of maximizing the utilization rate of the flexible material is realized by automatic typesetting. The graphic format of the graphic format file of the profile to be processed includes a CGM format and a CNS format.

S5. the graphic format file of the profile to be processed is converted, so as to generate a graphic language format file of the profile to be processed.

Because the generated graphic format file of the profile to be processed cannot be subjected to trajectory optimization, it is necessary to convert the graphic format file of the profile to be processed into the graphic language format file of the profile to be processed for trajectory optimization, wherein the graphic language format in the graphic language format file of the profile to be processed includes an HPGL format, a PLT format and an HPG format.

S6. trajectory optimization is performed on the graphic language format file of the profile to be processed according to the profile to be processed, so as to generate an industrial-standard HPGL instruction for trajectory optimization.

The profile to be processed of the flexible material is identified in the graphic language format file of the profile to be processed, the processing trajectory is set and optimized according to the profile to be processed, and the industrial-standard HPGL instruction for trajectory optimization which can be compiled by the control system is generated.

S7. the industrial-standard HPGL instruction for trajectory optimization is compiled, so as to generate a control signal.

By compiling the industrial-standard HPGL instruction for trajectory optimization, the control signal is generated to control the motion execution system.

S8. the control signal is transmitted to a motion execution system, and performing cutting by the motion execution system according to the control signal.

The motion execution system cuts the flexible material upon receiving the control signal.

In the prior art, in the process of processing the flexible material, the poor file compatibility among devices of various manufacturers and the discontinuous production process lead to reduction in the efficiency and precision of production of the flexible material. By the method for controlling the processing of this example, the problems of interconnection and interoperability among devices and systems of different manufacturers can be solved through standard conversion among the image of the flexible material, the vector data format file of profile information, the graphic format file of the profile to be processed, the graphic language format file of the profile to be processed, the industrial-standard HPGL instruction for trajectory optimization and the control signal, thereby improving the file compatibility and file conversion efficiency among the devices and systems of different manufacturers, improving the profile extraction accuracy, improving the utilization rate of the typeset material, and improving the cutting accuracy and the cutting effect. The present invention solves the technical problem that in the process of processing the flexible material, the poor file compatibility among devices of various manufacturers and the discontinuous production process lead to reduction in the efficiency and precision of production of the flexible material.

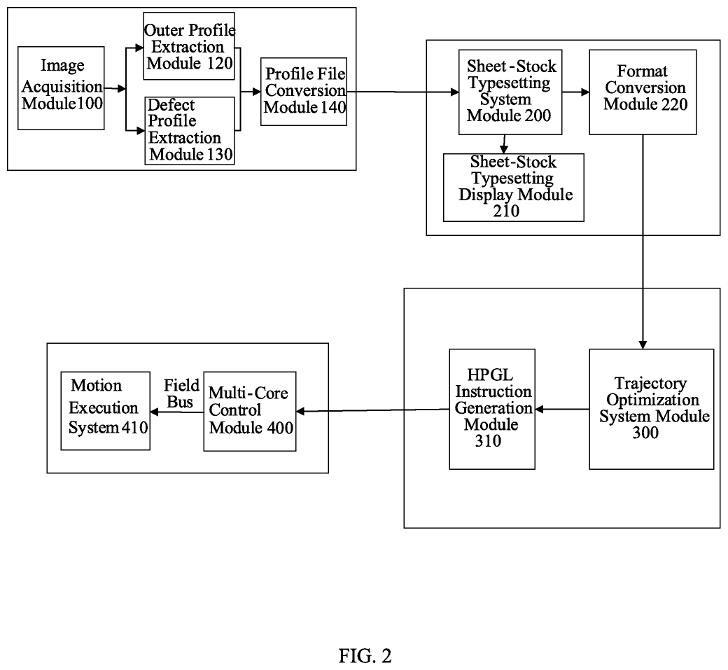

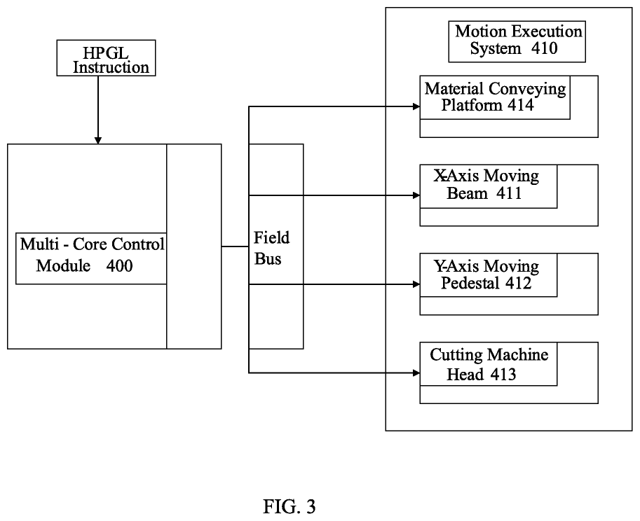

As shown in FIGS. 2 and 3, the present invention also provides a device for intelligently controlling continuous processing of a flexible material. The device for controlling the processing includes an image acquisition module 100, an outer profile extraction module 120, a defect profile extraction module 130, a profile file conversion module 140, a sheet-stock typesetting system module 200, a format conversion module 220, a trajectory optimization system module 300, an HPGL instruction generation module 310, a multi-core control module 400 and a motion execution system 410; the profile file conversion module 140 and the sheet-stock typesetting system module 200 are connected via Ethernet.

The image acquisition module 100 is used for acquiring an image of a flexible material placed on a conveying platform, and conveying the acquired image of the flexible material to the outer profile extraction module 120 and the defect profile extraction module 130; wherein the image acquisition module 100 is preferably a linear array scanning camera.

The outer profile extraction module 120 is used for extracting an outer profile of the received image of the flexible material, and sending the extracted outer profile to the profile file conversion module 140;

the defect profile extraction module 130 is used for extracting a defect profile of the received image of the flexible material, and sending the extracted defect profile to the profile file conversion module 140;

the profile file conversion module 140 is used for merging the received outer profile and defect profile to generate a vector data format file of profile information, and sending the vector data format file of profile information to the sheet-stock typesetting system module;

the sheet-stock typesetting system module 200 is used for comprehensively considering multi-dimensional information such as an outer profile, an defective profile, cuffed pieces, etc., so as to perform automatic typesetting of the outer profile within the vector data format file of profile information with avoidance from the defective profile, so as to generate a graphic format file of a profile to be processed, and sending the graphic format file of the profile to be processed to the format conversion module 220;

the format conversion module 220 is used for converting the received graphic format file of the profile to be processed, so as to generate a graphic language format file of the profile to be processed, and sending the graphic language format file of the profile to be processed to the trajectory optimization system module 300;

the trajectory optimization system module 300 is used for performing trajectory optimization on the received graphic language format file of the profile to be processed according to the profile to be processed, so as to generate processing trajectory information, and sending the processing trajectory information to the HPGL instruction generation module 310;

the HPGL instruction generation module 310 is used for generating an industrial-standard HPGL instruction from the received processing optimization trajectory information, and sending the industrial-standard HPGL instruction to the multi-core control module 400;

the multi-core control module 400 is used for compiling the industrial-standard HPGL instruction, so as to generate a control signal, and sending the control signal to the motion execution system 410;

the motion execution system 410 is used for receiving the control signal and cutting the flexible material according to the control signal.

The present invention solves the technical problem existed in the prior art that in the process of processing the flexible material, the discontinuous process leads to reduction in the efficiency and precision of production of the flexible material.

wherein, the device for controlling the processing also includes a sheet-stock typesetting display module 210;

the sheet-stock typesetting display module 210 is used for acquiring and displaying the typesetting information in the sheet-stock typesetting system module 200.

Through the sheet-stock typesetting display module 210, the profile to be processed of the typeset flexible material can be displayed, so that an operator can conduct observation and verification with avoidance from faults or typesetting problems. The sheet-stock typesetting display module 210 is preferably a display screen, and the profile to be processed as displayed in the sheet-stock typesetting display module 210 includes an outer profile, a defective profile, and an profile to be processed that is to be cut during typesetting, and various types of profiles will be distinguished by different colors.

The multi-core control module is used for driving control of the motion execution system, receiving the HPGL instruction, and driving the motion execution system to execute actions according to the industrial-standard HPGL instruction.

The motion execution system 410 includes a material conveying platform 414 for conveying the flexible material, an X-axis moving beam 411, a Y-axis moving pedestal 412 and a cutting machine head 413, wherein the X-axis moving beam 411 is mounted on the material conveying platform 414, the Y-axis moving pedestal 412 is movably mounted on the X-axis moving beam 411, and the cutting machine head 413 is mounted on the Y-axis moving pedestal 412 while being capable of moving up and down.

The motion execution system 410 controls the material conveying platform 414 to convey the flexible material according to the control signal, the X-axis moving beam 411 moves to the position where the flexible material is to be cut, and the Y-axis moving pedestal 412 drives the cutting machine head 413 to move to complete cutting of the flexible material.

It can be clearly understood by those skilled in the art that for the convenience of description and conciseness, the specific working processes of the systems, apparatuses and units described above can refer to the corresponding processes in the aforementioned method embodiments, and will not be described in detail here anymore.

The embodiments described above are only illustrative of the technical solutions of the present application, rather than limiting the utility model; although the present application is described in detail with reference to the foregoing embodiments, it should be understood by those of ordinary skills in the art that modifications still can be conducted to the technical solutions described in the foregoing embodiments or equivalent replacements can be conducted to some technical features in the foregoing embodiments; and these modifications and replacements would not make the nature of the corresponding technical solutions depart from the spirit and scope of the technical solutions of the embodiments of the present application.

I claim:

1. A method for intelligently controlling continuous processing of a flexible material, wherein the method for controlling the processing comprises the following steps:
S1. collecting a flexible material placed on a conveying platform by a collecting device, so as to acquire an image of the flexible material;
S2. generating an outer profile diagram and a defect profile diagram according to the image of the flexible material;
S3. respectively converting and merging the outer profile diagram and the defect profile diagram, so as to generate a vector data format file of profile information;
S4. typesetting the vector data format file of profile information, so as to generate a graphic format file of a profile to be processed;
S5. converting the graphic format file of the profile to be processed, so as to generate a graphic language format file of the profile to be processed;
S6. performing trajectory optimization on the graphic language format file of the profile to be processed according to the profile to be processed, so as to generate an industrial-standard HPGL instruction for trajectory optimization;
S7. compiling the industrial-standard HPGL instruction for trajectory optimization, so as to generate a control signal; and
S8. transmitting the control signal to a motion execution system, and performing cutting by the motion execution system according to the control signal.

2. The method for intelligently controlling continuous processing of a flexible material according to claim 1, wherein the typesetting process specifically comprises: comprehensively considering multi-dimensional information such as an outer profile, an defective profile, cutted pieces, etc., so as to perform automatic typesetting of the outer profile within the vector data format file of profile information with avoidance from the defective profile.

3. The method for intelligently controlling continuous processing of a flexible material according to claim 2, wherein the S2 specifically comprises:
identifying and extracting an outer profile and a defect profile from the image of the flexible material according to a convolution network deep learning algorithm, so as to acquire the outer profile diagram and the defect profile diagram.

4. The method for intelligently controlling continuous processing of a flexible material according to claim 3, wherein the collecting process in the S1 specifically comprises:
collecting the flexible material by a linear array scanning camera with a preset scanning range and a preset resolution.

5. The method for intelligently controlling continuous processing of a flexible material according to claim 4, wherein
the preset scanning range is 2 m×2 m, and the preset resolution is 0.06 mm/pixel.

6. The method for intelligently controlling continuous processing of a flexible material according to claim 5, wherein the format of the image of the flexible material comprises a JPG format, a PNG format, a GIF format, a BMP format, a TIF format and a PSD format;
the vector data format of the vector data format file of profile information comprises a DXF format, a DWG format, a DWT format and a DWS format;
the graphic format of the graphic format file of the profile to be processed comprises a CGM format and a CNS format;
the graphic language format in the graphic language format file of the profile to be processed comprises an HPGL format, a PLT format and an HPG format.

7. A device for intelligently controlling continuous processing of a flexible material, wherein the device for controlling the processing comprises an image acquisition module, an outer profile extraction module, a defect profile extraction module, a profile file conversion module, a sheet-stock typesetting system module, a format conversion module, a trajectory optimization system module, an HPGL instruction generation module, a multi-core control module, and a motion execution system;
the image acquisition module is used for acquiring an image of a flexible material placed on a conveying platform, and conveying the acquired image of the flexible material to the outer profile extraction module and the defect profile extraction module;
the outer profile extraction module is used for extracting an outer profile of the received image of the flexible material, and sending the extracted outer profile to the profile file conversion module;
the defect profile extraction module is used for extracting a defect profile of the received image of the flexible material, and sending the extracted defect profile to the profile file conversion module;
the profile file conversion module is used for merging the received outer profile and defect profile to generate a vector data format file of profile information, and sending the vector data format file of profile information to the sheet-stock typesetting system module;
the sheet-stock typesetting system module is used for comprehensively considering multi-dimensional information such as an outer profile, an defective profile, cuffed pieces, etc., so as to perform automatic typesetting of the outer profile within the vector data format file of profile information with avoidance from the defective profile, so as to generate a graphic format file of a profile to be processed, and sending the graphic format file of the profile to be processed to the format conversion module;
the format conversion module is used for converting the received graphic format file of the profile to be processed, so as to generate a graphic language format file of the profile to be processed, and sending the graphic language format file of the profile to be processed to the trajectory optimization system module;
the trajectory optimization system module is used for performing trajectory optimization on the received graphic language format file of the profile to be processed according to the profile to be processed, so as to generate processing trajectory information, and sending the processing trajectory information to the HPGL instruction generation module;
the HPGL instruction generation module is used for generating an industrial-standard HPGL instruction from the received processing optimization trajectory information, and sending the industrial-standard HPGL instruction to the multi-core control module;
the multi-core control module is used for compiling the industrial-standard HPGL instruction, so as to generate a control signal, and sending the control signal to the motion execution system;
the motion execution system is used for receiving the control signal and cutting the flexible material according to the control signal.

8. The device for intelligently controlling continuous processing of a flexible material according to claim 7, wherein the device for controlling the processing further comprises a sheet-stock typesetting display module;
the sheet-stock typesetting display module is used for acquiring and displaying the typesetting information in the sheet-stock typesetting system module.

9. The device for intelligently controlling continuous processing of a flexible material according to claim 8, wherein the multi-core control module is used for driving control of the motion execution system, receiving the HPGL instruction, and driving the motion execution system to execute actions according to the industrial-standard HPGL instruction.

10. The device for intelligently controlling continuous processing of a flexible material according to claim 9, wherein
the motion execution system comprises a material conveying platform for conveying the flexible material, an X-axis moving beam, a Y-axis moving pedestal and a cutting machine head, wherein the X-axis moving beam is mounted on the material conveying platform, the Y-axis moving pedestal is movably mounted on the X-axis moving beam, and the cutting machine head is mounted on the Y-axis moving pedestal while being capable of moving up and down.
